(19) United States
(12) Patent Application Publication
(10) Pub. No.: US 2016/0280897 A1
(43) Pub. Date: Sep. 29, 2016

(54) METHOD TO FORM AN AQUEOUS DISPERSION OF AN IONMOER-ETHYLENE COPOLYMER BLEND

(71) Applicant: E. I. DU PONT DE NEMOURS AND COMPANY, Wilmington, DE (US)

(72) Inventors: ALDO R. TAVAREZ, HOCKESSIN, DE (US); BENJAMIN ANDREW SMILLIE, KINGSTON (CA); TIMOTHY A. LIBERT, HOCKESSIN, DE (US); MARK R. ROHDE, WILMINGTON, DE (US); RICHARD ALLEN HAYES, BEAUMONT, TX (US)

(21) Appl. No.: 15/078,290

(22) Filed: Mar. 23, 2016

Related U.S. Application Data
(60) Provisional application No. 62/136,780, filed on Mar. 23, 2015.

(51) Int. Cl. C08L 23/08

(52) U.S. Cl. CPC C08L 23/0876; C08L 2201/50; C08L 2205/02

(57) ABSTRACT

A method to form an aqueous dispersion is provided. The aqueous dispersion comprises or is produced from a blend composition, which in turn comprises or consists essentially of about 75 to about 99.9 weight % of an ionomer composition and about 0.1 to about 25 weight % of an ethylene elastomer or an ethylene dicarboxyl copolymer. The method comprises mixing the solid blend composition with water heated to a temperature of from about 80 to about 100 ° C. Further provided are the dispersible blend compositions, the aqueous dispersions, and articles produced from the aqueous dispersions.

### CROSS-REFERENCE TO RELATED APPLICATION

This application claims priority under 35 U.S.C. §119 to U.S. Provisional Appln. No. 62/136,780, filed on Mar. 23, 2015, which is incorporated herein by reference in its entirety.

### FIELD OF THE INVENTION

Provided herein are blend compositions comprising ionomers and ethylene copolymers and a method to form aqueous dispersions comprising the blend compositions. Further provided are the aqueous dispersions, and articles produced from the aqueous dispersions.

### BACKGROUND OF THE INVENTION

Several patents and publications are cited in this description in order to more fully describe the state of the art to which this invention pertains. The entire disclosure of each of these patents and publications is incorporated by reference herein.

Ionomers of ethylene copolymers with alpha,beta-ethylenically unsaturated carboxylic acids are known in the art, wherein at least a portion of the carboxylic acid groups of the copolymer are neutralized to form carboxylate salts comprising alkali metal, alkaline earth metal or transition metal cations. See, for example, U.S. Pat. Nos. 3,264,272; 3,338,739; 3,355,319; 5,155,157; 5,244,969; 5,304,608; 5,688,869; 6,245,858; 6,518,365; and U.S. Patent Application Publication No. 2009/0297747.

Aqueous dispersions of ionomers are also known in the art. See, for example, U.S. Pat. Nos. 3,904,569; 4,136,069; 4,269,937; 4,508,804; 5,409,765; and Japanese Patent Application Nos. JP01009338 and JP05075769. The dispersions have been produced by dissolving the acid copolymer precursors in a solvent, neutralization of the acid functionalities with generally ammonia, amines or alkali metal ions, and dilution of the solution into water followed by partial or complete removal of the solvent. See, for example, U.S. Pat. Nos. 2,313,144; 3,389,109; 3,562,196; 5,430,111; 5,591,806; Japanese Patent Application Nos. JP50084687 and JP2009091426.

Aqueous ionomer dispersions have also been produced by heating acid copolymer precursors or ionomers in hot aqueous ammonia and other neutralizing agents. See, for example, U.S. Pat. Nos. 3,553,178; 3,644,258; 3,674,896; 3,823,108; 3,872,039; 3,899,389; 3,970,626; 3,983,268; 4,400,440; 4,540,736; 5,160,484; 5,206,279; 5,330,788; 5,387,635; 5,550,177; 6,852,792; U.S. Patent Application Publication No. 2007/0117916; Japanese Patent Application No. JP06000872; and PCT Patent Application Publication No. WO2000/044801.

Aqueous ionomer dispersions have also been produced by dispersing the acid copolymer precursor in aqueous solutions of neutralizing agents under high shear process conditions at temperatures above the boiling point of water, necessitating the use of pressure vessels such as autoclaves and extruders. See, for example, U.S. Pat. Nos. 5,082,697; 5,374,687; 5,993,604; 6,482,886; 7,279,513; 7,470,736; U.S. Patent Application Publication Nos. 2006/0124554; 2007/0243331; PCT International Patent Application No. WO2011/087478; and Japanese Patent Application Nos. JP 10006640; and JP50135141.

Aqueous ionomer dispersions have also been produced by dispersing the ionomer in aqueous solutions under high shear process conditions at temperatures above the boiling point of water, necessitating the use of pressure vessels such as autoclaves and extruders. See, for example, U.S. Pat. Nos. 4,173,669; 4,329,305; 4,410,655; 6,458,897; Japanese Application Nos. JP11158332; JP2005075878; JP 200575879; and PCT Patent Application Publication No. WO1999/10276.

Aqueous ionomer dispersions have also been produced by dispersing highly neutralized, low melt index (MI) ionomers in hot water. See for example U.S. Pat. Nos. 3,321,819; 3,472,825; and 4,181,566.

Blends incorporating a polyolefin with an ionomer are known. See for example U.S. Pat. Nos.5,179,168; 5,445,893; 5,542,677; 5,591,803; 6,100,336; U.S. Patent Application Publication No. US 20080132628; PCT Patent Application Publication No. WO2009072600; and Japanese Patent Application Nos. JP09-040924; JP09-175592; JP10-060186; JP10-316872; JP11-147288; JP11-291406; JP2868862; JP3356376; JP3878268; JP3926486; JP3985881; JP4197901; JP2002-012722; JP2002-234975; JP2003-026868; JP2003-291283; JP2004-217759; JP2006-026986; JP2007-138004; JP2007-301797; JP2007-302764; JP2008-138116; JP2008-273998; JP2009-035699; JP2009-084324; JP2009-101677; JP2009-138139; JP2868862; JP09040924; JP09175592; and JP3599912.

Aqueous dispersions incorporating a major portion of a polyolefin with a minor portion of an ionomer, generally functioning as a dispersant for the polyolefin, are known. See for example U.S. Pat. Nos. 3,296,172; 3,356,629; 3,896,065; 4,174,335; 4,336,210; 4,440,908; 4,775,713; 4,970,258; 4,978,707; 7,439,276; 7,528,080; 7,588,662; U.S. Patent Application Publication Nos. 2005/0271888; 2007/0137808; 2007/0137809; 2007/0137810; 2007/0137811; 2007/0137813; 2007/0144697; 2007/0284069; 2007/0292705; 2007/0295464; 2007/0295465; 2008/0000598; 2008/0000602; 2008/0009586; 2008/0041543; 2008/0073045; 2008/0073046; 2008/0076844; 2008/0135195; 2008/0230195; 2008/0216977; 2008/0295985; 2009/0202829; 2009/0253321; PCT Patent Application Publication Nos. WO2007/008633; WO2008/052122; WO2009/035877; WO2009/055275; WO2009/064993 and Japanese Patent Application Nos. JP2958102; JP 2001-1355185.

Aqueous dispersions incorporating a major portion of a polyolefin with a minor portion of an ionomer have also been produced by dispersing the polyolefin and the ionomer in aqueous solutions under high shear process conditions at temperatures above the boiling point of water, necessitating the use of pressure vessels such as autoclaves and extruders. See, for example, U.S. Patent Application Publication Nos. 2005/0100754; 2007/0141323; 2008/0118728; 2008/0176968; 2008/0182040; 2008/0292833; 2009/0194450; 2010/0048784; 2010/0137501; and PCT Patent Application Publication Nos. WO2005/021638; WO2008/005501; WO2009/045731; WO2011/058121; WO2011/068525.

Aqueous dispersions incorporating a major portion of ionomer and a minor portion of polar polyolefin were produced, for example, by mixing preformed dispersions of each component. See, for example, British Patent No. GB 1243303; European Patent Application No. EP1163276; and Japanese Application No. JP2000328046.

Aqueous dispersions incorporating a major portion of ionomer and a minor portion of polar polyolefin were produced, for example, by preparing a solid blend of an acid copolymer with the polar polyolefin, and treating the blend with a heated aqueous ammonia solution. See, for example, PCT Patent Application Publication No. WO2011/058119.

Finally, in U.S. Pat. No. 8,841,379, a method to form an aqueous dispersion is described. The dispersion comprises a blend composition comprising or consisting essentially of about 75 to about 99.9 weight % of an ionomer composition and about 0.1 to about 25 weight % of an ethylene acrylate ester copolymer composition, a grafted polyolefin composition or a combination thereof. The method comprises mixing the solid blend composition with water heated to a temperature from about 80 to about 100° C.

There remains a need, however, for aqueous dispersions that have a variety of compositions and that can be prepared under similarly mild conditions.

### SUMMARY OF THE INVENTION

Accordingly, provided herein is a blend composition comprising or consisting essentially of

(a) about 60 to about 99.9 weight % of an ionomer composition comprising or consisting essentially of an ionomer that is derived from a parent acid copolymer, said parent acid copolymer comprising copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the parent acid copolymer, based on the total carboxylic acid content of the parent acid copolymer as calculated for the non-neutralized parent acid copolymer, are neutralized to form the ionomer, which ionomer in turn comprises carboxylate groups with counterions comprising potassium cations, sodium cations or combinations thereof; and

(b) about 0.1 to about 40 weight %, based on the combination of (a) and (b), of (i) an ethylene elastomer comprising copolymerized units of ethylene, about 45 to about 80 weight % of copolymerized units of at least one alpha,beta-ethylenically unsaturated carboxylic acid ester, based on the total weight of the ethylene elastomer, and optionally about 0.5 to about 10 weight % of copolymerized units of 2-butene-2,4-dioic acid or its derivative, wherein the derivative is an anhydride of the acid or a monoalkyl ester of the acid; or (ii) ethylene dicarboxyl copolymer comprising copolymerized units of ethylene and copolymerized units of a dicarboxyl comonomer comprising an anhydride group, a vicinal pair of carboxylic groups or a carboxylic group adjacent to an alkoxycarbonyl group.

Further provided herein is a method for making an aqueous dispersion comprising a mixture of an ionomer and an ethylene elastomer or an ethylene dicarboxyl copolymer, the method comprising or consisting essentially of the steps of:

(1) providing the blend composition, preferably as a solid, such as a powder or pellets;

(2) mixing the blend composition under low shear conditions with water heated to a temperature of from about 80 to about 100° C. to provide a heated aqueous blend dispersion; and

(3) optionally cooling the heated aqueous blend dispersion to a temperature of about 20 to 30° C. At these temperatures, the polymer blend remains dispersed in the liquid phase.

In one embodiment, the method further comprises the steps of forming an article from the preformed solid blend composition and adding the article to water at a temperature of about 20 to 30° C., to form a mixture of the solid blend composition and water; and subsequently heating the mixture to a temperature of from about 80 to about 100° C. The article disperses into the heated water under low-shear mixing conditions.

In another embodiment, the method further comprises the steps of forming an article from the preformed solid blend composition and adding the article to water preheated to a temperature from about 80 to about 100° C. The article disperses into the heated water under low-shear mixing conditions.

Further provided herein is an aqueous dispersion of the blend composition. The aqueous dispersion may be produced using the methods described above. Further provided herein is an article comprising or produced from the aqueous dispersion.

### DETAILED DESCRIPTION OF THE INVENTION

Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight.

When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized comonomers.

As used herein, “disperse,” “dispersing” and related terms refer to a process in which solid articles such as pellets of polymer are mixed with water and over a brief period of time disappear into the liquid phase. The terms “aqueous dispersion” and “dispersion” describe a transparent, free-flowing liquid with no solids visible to the human eye. No characterization is made regarding the interaction of the polymer molecules with the water molecules in such aqueous dispersions. “Self-dispersible” means that the material disperses readily in hot (80 to 100° C.) water without need for additional dispersants or reagents.

Methods to produce aqueous dispersions comprising certain ionomer-ethylene copolymer blends are described herein. Surprisingly, it has been found that ionomer-ethylene copolymer blends with certain compositional characteristics readily form aqueous dispersions when mixed with hot water at atmospheric pressure and under low shear conditions. This dispersion method provides a process simplification that requires less energy and is inherently safer than the prior art dispersion methods, which required more rigorous conditions such as high pressure, high-shear mixing, autoclave processing or extrusion processing.

The blend compositions described herein comprise (a) about 60 to about 99.9 weight %, based on the combination of (a) and (b), of an ionomer composition, and (b) about 0.1 to about 40 weight, based on the combination of (a) and (b), of (i) an ethylene elastomer; (ii) ethylene dicarboxyl copolymer; or (iii) a combination of (i) and (ii). Each of the components of the blend is described in more detail below.

### Ionomer Composition

Importantly, the ionomer compositions combine the properties of being self-dispersible in hot water along with being thermoplastic, allowing for melt fabrication into many articles of commerce. Accordingly, suitable ionomers are derived from certain parent acid copolymers comprising copolymerized units of ethylene and about 18 to about 30 weight % of copolymerized units of an alpha, beta-ethylenically unsaturated carboxylic acid such as acrylic acid or methacrylic acid. Preferably, the parent acid copolymers comprise about 19 to about 25 weight %, or more preferably about 19 to about 23 weight %, of the alpha, beta-ethylenically unsaturated carboxylic acid, based on the total weight of the copolymer. Complementarily, the amount of copolymerized ethylene residues in the parent acid copolymers is about 70 to about 82 wt %, or about 75 to about 81 wt %, or more preferably about 77 to about 81 wt %. Stated alternatively, the sum or the weight percentages of the copolymerized residues of all the comonomers in the parent acid copolymers is 100 wt %.

Preferably, the alpha, beta-ethylenically unsaturated carboxylic acid is methacrylic acid. Of note are acid copolymers consisting essentially of copolymerized units of ethylene and copolymerized units of the alpha, beta-ethylenically unsaturated carboxylic acid and 0 weight % of additional comonomers, that is, dipolymers of ethylene and the alpha, beta-ethylenically unsaturated carboxylic acid. Preferred acid copolymers are ethylene methacrylic acid dipolymers.

The parent acid copolymers used herein may be polymerized as disclosed in U.S. Pat. Nos. 3,404,134; 5,028,674; 6,500,888; and 6,518,365, for example.

The parent acid copolymers used herein preferably have a melt flow rate (MFR) of about 200 to about 1000 grams/10 min, as measured by ASTM D1238 at 190° C. using a 2160 g load. A similar ISO test is ISO 1133. Alternatively, the parent acid copolymers have melt flow rates ranging from a lower limit of 200, 250 or 300 grams/10 min to an upper limit of 400, 500, 600 or 1000 grams/10 min. The preferred melt flow rate of the parent acid copolymer provides ionomers with optimum physical properties in the final shaped article while still allowing for rapid self-dispersion in hot water. Ionomers derived from parent acid copolymers with melt flow rates below about 200 grams/10 minutes have minimal hot water self-dispersability, while ionomers derived from parent acid copolymer melt flow rates of greater than about 1000 grams/10 minutes may not have the physical properties required for the intended end use.

In some embodiments, blends of two or more ethylene acid copolymers may be used, provided that the aggregate components and properties of the ionomer blend fall within the limits described above for the ethylene acid copolymers. For example, two ethylene methacrylic acid dipolymers may be used such that the total weight % of methacrylic acid is about 18 to about 30 weight % of the total polymeric material and the melt flow rate of the blend is about 200 to about 1000 grams/10 min.

Suitable ionomers are produced from the suitable parent acid copolymers, wherein from about 50 to about 70%, or preferably from about 55 to about 60%, or about 60%, of the total carboxylic acid groups of the parent acid copolymers, as calculated for the non-neutralized parent acid copolymers, are neutralized to form carboxylic acid salts with cations as counterions. Any cation that is stable under processing conditions is suitable. Preferred are monovalent and divalent cations, including without limitation alkali metal cations, such as sodium, potassium or lithium; alkaline earth metal cations, such as zinc cations; and combinations of two or more monovalent and divalent cations. Monovalent cations are more preferred, and sodium and potassium cations are still more preferred. Ionomers having cations that consist essentially of sodium cations are notable. The parent acid copolymers may be neutralized using methods described in, for example, U.S. Pat. No. 3,404,134.

Preferably, the ionomers used herein have a melt flow rate (MFR) of at least 1 gram/10 min, such as about 1 to about 20 grams/10 min as measured by ASTM D1238 at 190° C. using a 2160 g load. More preferably, the ionomer composition has a MFR of about 1 to about 10 grams/10 min, and most preferably has a MFR of about 1 to about 5 grams/10 min. The combination of the above described parent acid copolymer melt flow rates and the neutralization levels provides ionomers which combine the properties of being easily self-dispersable in hot water and easily melt fabricated into articles of commerce.

In some embodiments, blends of two or more ionomers may be used, provided that the aggregate components and properties of the blend fall within the limits described above for the ionomers.

The ionomer composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, fillers, and coupling agents. Other suitable additives, additive levels, and methods of incorporating the additives into the ionomer compositions may be found in the Kirk-Othmer Encyclopedia of Chemical Technology, 5th Edition, John Wiley & Sons (New Jersey, 2004). In general, the total amount of these other additives, if present, is less than 5 wt %, less than 3 wt %, less than 2 wt %, or less than 1 wt %, based on the total weight of the ionomer composition.

### Ethylene Elastomer

The ethylene elastomer may comprise, be produced from, or consist essentially of copolymerized units of ethylene, about 45 to about 80 weight %, or about 45 to about 75 weight %, or about 55 to about 80 weight %, or about 50 to about 70 weight %, or about 50 to about 80 weight % of copolymerized units of at least one alpha, beta-ethylenically unsaturated carboxylic acid ester, based on the total weight of the ethylene ester and optionally about 0.5 to about 10 weight %, about 1 to about 5 weight %, about 1.5 to about 5 weight %, about 1.5 to about 4 weight %, or about 1.5 to about 3 weight %, of copolymerized units of 2-butene-2,4-dioic acid or its derivative, wherein the derivative is an anhydride of the acid or a monoalkyl ester of the acid. Complementarily, the amount of copolymerized ethylene residues ranges from about 45 wt % to about 10 wt %, again based on the total weight of the ethylene ester.

A suitable ethylene elastomer dipolymer can comprise copolymerized ethylene residues and about 45 to about 80 weight %, 45 to about 75 weight %, or about 55 to about 80 weight %, or 50 to 70 weight %, or about 50 to about 80 weight % of a copolymerized (meth)acrylate or alkyl(meth)acrylate such as methyl acrylate. The alkyl group can have 1 to 8 carbons, preferably 1 to 4 carbons. The suitable dipolymer can have a number average molecular weight (MO above 20,000, above 30,000, above 40,000, or above 55,000 daltons, with an upper limit of about 100,000 or about 150,000 daltons; and a melt index from 2 to 20, or from 2 to 12 g/10 min, as measured by ASTM D1238 at 190° C. using a 2160 g load; and preferably a polydispersity from about 2 to about 10.

A suitable ethylene elastomer terpolymer can comprise copolymerized ethylene, a copolymerized alkyl(meth)acrylate, and a copolymerized 2-butene-2,4-dioic acid or its derivative. The suitable terpolymer may comprise about 45 to about 70 weight % of repeat units derived from alkyl(meth)acrylate. In addition, the suitable terpolymer may comprise about 0.5 to about 10 weight %, about 1 to about 5 weight %, about 1.5 to about 5 weight %, about 1.5 to about 4 weight %, or about 1.5 to about 3 weight % of repeat units derived from 2-butene-2,4-dioic acid or its derivative, in which the derivative is an anhydride of the acid or a monoalkyl ester of the acid. The alkyl group in the monoalkyl ester can have 1 to about 6 carbon atoms. Complementarily, the repeat units derived from ethylene can comprise the remainder up to 100 wt %, based on the total weight of the ethylene elastomer terpolymer. The terpolymer can have a number average molecular weight (MO above 20,000, above 40,000, or above 43,000 daltons, with an upper limit of about 100,000 or about 150,000 daltons; a melt index preferably from about 1 to about 30 g/10 min, as measured by ASTM D1238 at 190° C. using a 2160 g load; and preferably a polydispersity from about 2 to about 10.

A suitable ethylene elastomer terpolymer or a tetrapolymer can comprise copolymerized units of ethylene, a first alkyl(meth)acrylate, a second alkyl(meth)acrylate, and, optionally, a 2-butene-2,4-dioic acid or its derivative. The terpolymer or tetrapolymer may comprise about 10 to about 40 weight % or about 20 to about 30 weight % of repeat units derived from the first alkyl(meth)acrylate; and about 15 to about 65 weight % or about 35 to about 45 weight % of repeat units derived from the second alkyl(meth)acrylate. For example, the total amount of copolymerized alkyl(meth)acrylates may be about 45 to about 80 weight %, based on the total weight of the ethylene elastomer terpolymer or tetrapolymer. The first alkyl(meth)acrylate and the second alkyl(meth)acrylate are different although they can be selected from the same group. The first alkyl(meth)acrylate and the second alkyl(meth)acrylate can each independently have 1 to 4 carbons in the alkyl group. The ethylene elastomer terpolymer or tetrapolymer may include 0 to about 5 weight %, about 1 to 5 weight %, or about 2 to 5 weight % of repeat units derived from the 2-butene-2,4-dioic acid or its derivative. The amount of copolymerized ethylene in the terpolymer or tetrapolymer is complementary to the amounts of alkyl(meth)acrylate(s) and 2-butene-2,4-dioic acid or derivative(s). The copolymer can have a number average molecular weight (Mₙ) above 40,000, alternatively above 48,000, alternatively above 60,000 daltons; preferably a Mₙ with an upper limit of about 100,000 or about 150,000 daltons; a melt index (MI) preferably about 3 to about 30 g/10 minutes, as measured by ASTM D1238 at 190° C. using a 2160 g load; and a polydispersity preferably from about 2 to about 12, or from 2.5 to 10.

In some embodiments, the ethylene elastomer or ethylene acrylic elastomer is cross-linkable to form a thermoset material. In these embodiments, the ethylene elastomer or ethylene acrylic elastomer is provided in a cross-linkable composition that further comprises or is produced from a curing agent; one or more additional polymers including thermosets such as epoxy resins, phenolic resins or vinyl ester resins subject to further curing; or thermoplastics such as polyamides. The cross-linkable composition is prevented from cross-linking until after the dispersion is formed, or until after the end-use of the dispersion is achieved, for example by maintaining processing temperatures below the activation temperature of any curing agent, or by preventing exposure to any initiator until cross-linking is desired.

Optionally, the ethylene elastomer or ethylene acrylic elastomer may further comprise one or more additives, of the types and in the amounts described above with respect to the ionomer composition. Filler, reinforcing fiber, fibrous structure of pulps, and combinations of two or more thereof are notable additives for the ethylene elastomer or ethylene acrylic elastomer.

Specific examples of suitable ethylene elastomers include ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, and combinations of two or more thereof.

Such ethylene elastomers can be produced by well-known processes such as those disclosed in U.S. Pat. Nos. 7,521,503, 7,544,757, or 7,608,675. More specifically, ethylene elastomers can be readily produced by copolymerizing, for example, ethylene and one or more alkyl(meth)acrylate(s) in the presence of a free-radical polymerization initiator including, for example, peroxygen compounds or azo compounds. Copolymers with acid cure sites, such as 2-butene-2,4-dioic acid or its derivative, can be similarly produced by copolymerizing ethylene, alkyl(meth)acrylate(s) and 2-butene-2,4-dioic acid moieties, for example anhydrides, or monoalkyl esters thereof. The copolymerizations can be run by continuously feeding ethylene and the comonomer(s), a free radical initiator, and optionally a solvent such as methanol or the like (see e.g., U.S. Pat. No. 5,028,674) to a stirred autoclave of the type described in U.S. Pat. No. 2,897,183. Alternatively, other high-pressure reactor designs generally known in the art as an autoclave may be employed. Provided that the autoclave is capable of supplying sufficient mixing, residence time, temperature and pressure control to the reaction mixture, it may be operated either alone or in series, with or without inter-stage cooling or heating, or with multiple compartments and feed zones. Reactor dimensions such as volume, length and diameter may also influence the selection of suitable operating conditions. The comonomers' rate of conversion may depend on variables such as the polymerization temperature and pressure, monomer feed temperature, the different monomers employed, concentration of the monomers in the reaction mixture, and residence time for the desired yield and copolymer composition. It may be desirable to adjust the residence time and, in some cases, to use a telogen (chain transfer/chain terminating agent), such as propane, to adjust the molecular weight. The reaction mixture is continuously removed from the autoclave. After the reaction mixture leaves the reaction vessel, the copolymer can be separated from the unreacted monomers and solvent (if present) by vaporizing the unpolymerized materials and solvent under reduced pressure and at an elevated temperature, for example. The copolymerization can be carried out at a temperature of from 120° C. to 200° C., or from 135° C. to 170° C.; at a pressure of from 1800 to 3000 kg/cm², or from 2000 to 2800 kg/cm²; and at a feed temperature of from 30° C. to 90° C., or from 50° C. to 90° C. After the continuous polymerization has reached a steady state, the total per-pass conversion of monomers to polymer may vary from 5 to 25 weight %, based on the total weight of comonomers in the feed.

The selection of an appropriate peroxide initiator depends on the reactor operating conditions, for example on the temperature and pressure, comonomers used, comonomer concentration, and inhibitors that are typically present in commercially available comonomers. The initiator can be added to the reaction mixture as a neat liquid, or dissolved or diluted in a suitable solvent, such as odorless mineral spirits, or mixed with a second, different initiator. The amount of peroxide injected may vary with the acrylate types, the level of the residuals, and the twin-screw extruder processing conditions. A typical range may be from 200 ppm to 8000 ppm, alternatively from 500 ppm to 5000 ppm. Residual levels in the finished copolymer are preferably below 2500 ppm, more preferably below 1500 ppm, and even more preferably below 1000 ppm. Preferably, the peroxide initiators decompose rapidly within a temperature range of 150 to 250° C.

Common classes of organic peroxides useful as free radical initiators include dialkyl peroxides, peroxy esters, peroxy dicarbonates, peroxy ketals, and diacyl peroxides. Examples of suitable peroxides include dicumyl peroxide, 1,1-di-(t-butylperoxy)-3,3,5-trimethylcyclohexane, 2,5-bis(t-butylperoxy)-2,5-dimethyl hexane, and α,α-bis(t-butylperoxy)diisopropylbenzene, di(3,3,5-trimethyl hexanoyl) peroxide, tert-butyl peroxypivalate, tert-butyl peroxyneodecanoate, di(sec-butyl) peroxydicarbonate, and tent-amyl peroxyneodecanoate. In addition, some suitable peroxides are available under the tradenames LUPEROX™ from Arkema or TRIGONOX™ from Akzo Nobel. Similarly, suitable azo initiators can be useful as free radical initiators.

It may be desirable to increase the molecular weight of an ethylene elastomer. In one suitable method, a blend of the ethylene elastomer and a curing agent, optionally including other additives or polymers, is subjected to a curing step for a sufficient time and at a sufficiently high temperature to achieve covalent chemical bonding (i.e., crosslinking). Crosslinking involves curing the compounded composition at elevated temperature for sufficient time to form covalent chemical bonds between individual polymer molecules. For example, a lightly crosslinked ethylene copolymer may be formed and cured using known reagents and procedures at about 90° C. to about 140° C. for up to about 60 minutes. Additional curing, annealing or heating may be conducted at about 90° C. to about 140° C. for several hours.

Finally, suitable ethylene elastomers are commercially available from E.I. du Pont de Nemours and Company (“DuPont”) of Wilmington, Del., as VAMAC® ethylene acrylic elastomers.

### Ethylene Dicarboxyl Copolymer

Alternatively, the blend composition comprises an ethylene dicarboxyl copolymer comprising, produced from, or consisting essentially of copolymerized units of ethylene and copolymerized units of a dicarboxyl comonomer comprising an alpha,beta-ethylenically unsaturated bond and an anhydride group, a vicinal pair of carboxylic groups or a carboxylic group adjacent to an alkoxycarbonyl group, wherein the alkoxy group contains up to 20 carbon atoms. The ethylene dicarboxyl copolymer is obtained by copolymerization of ethylene and at least one comonomer capable of copolymerizing with ethylene such as an alpha,beta-ethylenically unsaturated comonomer comprising an anhydride or a functional equivalent thereof, such as a vicinal pair of carboxylic groups or a carboxylic group adjacent to an alkoxycarbonyl group. Suitable comonomers includes anhydrides of C₄-C₈ unsaturated alpha,beta-ethylenically unsaturated dicarboxylic acids, C₄-C₈ unsaturated alpha,beta-ethylenically unsaturated acids having at least two carboxylic groups, monoesters or diesters of C₄-C₈ unsaturated alpha,beta-ethylenically unsaturated acids having at least two carboxylic groups, and mixtures of two or more suitable comonomers.

Specific examples of suitable comonomers include unsaturated anhydrides such as maleic anhydride and itaconic anhydride; 1,4-butenedioic acids (e.g. maleic acid, fumaric acid, itaconic acid and citraconic acid); and C₁-C₂₀ alkyl monoesters of the 1,4-butenedioic acids, including methyl hydrogen maleate, ethyl hydrogen maleate, propyl hydrogen fumarate, and 2-ethylhexyl hydrogen fumarate. Of these, maleic anhydride, ethyl hydrogen maleate and methyl hydrogen maleate are preferred. Maleic anhydride, ethyl hydrogen maleate (EHM), and mixtures of maleic anhydride and ethyl hydrogen maleate are more preferred.

Also preferred are copolymers of ethylene and monoalkyl maleates (also known as alkyl hydrogen maleates). As used herein, the term “ethylene/monoalkyl maleate copolymers” refers to such copolymers prepared from ethylene and a maleic acid monoester (sometimes referred to as a “half-ester,” wherein one carboxyl group of the maleic moiety is esterified and the other is an unesterified carboxylic acid).

The ethylene dicarboxyl copolymer may comprise about 6 to about 25 weight % of copolymerized units of the dicarboxyl comonomer, based on the total weight of the ethylene dicarboxyl copolymer. Alternatively, the level of copolymerized units of the dicarboxyl comonomer (for example, ethyl hydrogen maleate) is from a lower limit of about 6, 8 or about 10 weight % to an upper limit of about 18, about 20, or about 25 weight %. Notable ethylene dicarboxyl copolymers comprise about 6 to about 10 wt % or about 6 to about 15 wt % of copolymerized units of the dicarboxyl comonomer. Complementarily, the ethylene dicarboxyl copolymer comprises about 75 to about 94 wt % of copolymerized ethylene repeat units, based on the total weight of the ethylene dicarboxyl copolymer.

Suitable ethylene dicarboxyl copolymers include terpolymers and tetrapolymers, which comprise one or more additional comonomers. For example, E/X/Y terpolymers are suitable, wherein E is ethylene; X is a monomer selected from the group consisting of vinyl acetate and alkyl (meth)acrylates; and Y is a maleic acid monoester, including maleic monoesters of C₁ to C₄ alcohols, such as for example, methyl, ethyl, n-propyl, isopropyl, and n-butyl alcohols, wherein the amount of X is less than 15 weight %, and preferably less than 5 weight %, based on the total weight of the E/X/Y terpolymer. The amounts of copolymerized ethylene and maleic acid monoester in the E/X/Y terpolymer are as set forth above with respect to the dipolymers of ethylene and dicarboxyl comonomer. Suitable alkyl(meth)acrylates (component “X”) include (meth)acrylic acid esters of C₁ to C₄ alcohols. For example, suitable acrylate esters include methyl acrylate and butyl acrylate and suitable alkyl methacrylate esters include methyl methacrylate and n-butyl methacrylate. Preferably, when the copolymer is a higher order polymer such as a terpolymer, the combined comonomers other than ethylene are present in an amount of about 6 to about 30 weight % of the copolymer. Complementarily, the copolymer includes 70 to 94 wt % of copolymerized repeat units of ethylene, based on the total weight of the terpolymer or tetrapolymer. Notably, the alcohol moiety (alkoxy group) that is present in the maleic acid monoester comonomer may be the same as or different from alcohol moiety that is present in the alkyl(meth)acrylate comonomer.

Specific examples of suitable ethylene dicarboxyl copolymers include, without limitation, ethylene/maleic acid monoester dipolymers, such as ethylene/ethyl hydrogen maleate dipolymer; ethylene/maleic acid monoester/methyl acrylate terpolymers; ethylene/maleic acid monoester/methyl methacrylate terpolymers; ethylene/maleic acid monoester/ethyl acrylate terpolymers; ethylene/maleic acid monoester/ethyl methacrylate terpolymers; ethylene/maleic acid monoester/n-butyl acrylate terpolymers; and ethylene/maleic acid monoester/n-butyl methacrylate terpolymers. Of particular note are ethylene/alkyl hydrogen maleate copolymers wherein the alkyl group is ethyl.

The ethylene dicarboxyl copolymer may have a melt index from about 5 to about 400 g/10 min., preferably about 5 or about 10 to about 100 g/min, as measured by ASTM D1238 at 190° C. using a 2160 g load. A representative ethylene dicarboxyl copolymer is a random copolymer having a melt index of about 5 to 100 grams/10 minutes and consisting essentially of copolymerized ethylene and a monoalkyl ester of a 1,4-butenedioic acid in which the alkyl group has 1 to 4 carbon atoms. Preferably, the ethylene dicarboxyl copolymer is a dipolymer of ethylene and about 4 to about 25 weight %, or more preferably about 8 to about 20 weight %, of ethyl hydrogen maleate (an “EMAME” copolymer). A specific polymer may comprise from about 8 to about 10 weight % of ethyl hydrogen maleate. Another specific copolymer comprises about 15 weight % of ethyl hydrogen maleate. Such copolymers are commercially available from DuPont as Fusabond® functionalized resins.

Ethylene/ethyl hydrogen maleate terpolymers are also known. For example, a terpolymer of 46.4% ethylene, 50% methyl acrylate and 3.6% of monoethyl maleate (MAME) is described in U.S. Pat. No. 3,972,961. Preferably, the amount of MAME in the copolymer is from about 6 to about 20 weight % and the amount of additional comonomer (vinyl acetate, alkyl acrylate or alkyl methacrylate is less than or equal to 15 or less than or equal to 6 weight % of the terpolymer. The amount of copolymerized ethylene is complementary to the amounts of copolymerized MAME and alkyl(meth)acrylate or vinyl acetate.

Preferably the EMAME copolymer or the EMAME terpolymer has a melting point higher than 80° C.

These EMAME copolymers may be synthesized by random copolymerization of ethylene and the particular comonomer(s) in a high-pressure free radical process, generally an autoclave process. For example, ethylene/monoalkyl maleate copolymers can be obtained using a suitable high-pressure process described, for example, in U.S. Pat. No. 4,351,931. Some examples of ethylene/ester copolymers are described in U.S. Patent Application Publication No. 2005/0187315.

### Blend Composition

The blend compositions described herein comprise or consist essentially of (a) about 60 to about 99.9 weight %, or about 75 to about 99 weight %, or about 80 to about 99 weight %, or about 90 to about 99 weight %, or about 95 to about 99 weight %, based on the total weight of the combination of (a) and (b), of an ionomer composition, and (b) about 0.1 to about 40 weight %, or about 1 to about 25 weight %, or about 1 to about 20 weight %, or about 0.1 to about 10 weight %, or about 1 to about 5 weight %, based on the total weight of the combination of (a) and (b), of (i) an ethylene elastomer; or (ii) ethylene dicarboxyl copolymer; or (iii) a combination of (i) and (ii).

Of note is the blend composition consisting essentially of the ionomer and at least one ethylene elastomer, such as a blend comprising about 3 to about 15 weight % of elastomer or about 3 to about 15 weight % of a combination of two different elastomers. Also of note is the blend composition consisting essentially of the ionomer and the ethylene dicarboxyl copolymer.

The blends can be produced by any suitable high shear, intensive melt mixing process known in the art. Preferably, such a process would involve intensive mixing of the molten ionomer composition with the ethylene acrylate ester copolymer composition or the grafted polyolefin composition. For example, the intensive mixing may be provided by static mixers, rubber mills, Brabender mixers, Buss kneaders, single screw extruders or twin screw extruders. Extruders are the most convenient to use because of their high throughput; option for modular construction and ease of assembly; choice of many mixing screws; and ease of control and maintenance of process temperatures.

The ionomer composition, the ethylene elastomer and the ethylene dicarboxyl copolymer can be dried prior to any mixing step. The blend composition resins can be mixed as a dry blend, typically referred to as a “pellet blend”, prior to feeding to the melt mixing process. Alternatively, the blend composition resins can be co-fed through two or more different feeders. In an extrusion process, the blend composition resins would typically be fed into the back, feed section of the extruder. However, the blend composition resins may also advantageously be fed independently into two different locations of the extruder. For example, the ionomer composition can be added in the back, feed section of the extruder while the ethylene elastomer or the ethylene dicarboxyl copolymer is fed in the front of the extruder near the die plate. The extruder temperature profile is designed to allow the blend components to melt under the processing conditions. The screw design will also provide stress and, in turn, heat, to the molten resins. Generally, the blend components' melt processing temperature will be within the range of about 50° C. to about 300° C. The exact processing conditions will depend on the chemical compositions of the blend component resins used.

After the blend composition has been melt blended, it is removed from the mixer and allowed to cool and form a solid. For example, the melt blend is extruded through a die, cut into pellets and quenched in a cooling bath.

The ethylene elastomer and the ethylene dicarboxyl copolymer are not dispersible in hot water through the dispersion method described below in the absence of the ionomer blend component. Pellets or other articles comprising the ethylene elastomer or the ethylene dicarboxyl copolymer are also not dispersible in hot water, even in the presence of pellets or other articles comprising the dispersible ionomer composition. Without being held to theory, it is believed that the ethylene elastomer and the ethylene dicarboxyl copolymer must attain a small enough particle size through the melt compounding process to permit the self-dispersibility of the total blend. Hypothetically, the level of the ethylene elastomer and the ethylene dicarboxyl copolymer is advantageously low, as described above, so that these materials are maintained as the dispersed phase within a continuous phase of ionomer. It is hypothesized that the compatibility of the ethylene elastomer and the ethylene dicarboxyl copolymer with the ionomer enables them to achieve a small particle size in the blend compositions. For this reason, it is believed that the relatively hydrophobic ethylene elastomer and the ethylene dicarboxyl copolymer are dispersed in water.

### Dispersion Method

The dispersion method described herein surprisingly allows for the production of aqueous dispersions of combinations of ionomers and certain ethylene copolymers under very mild process conditions, such as low shear (e.g., simply stirring a solid blend of an ionomer and the ethylene copolymer and hot water) and low temperature (less than the boiling point of water at atmospheric pressure). These mild conditions require less energy than prior art dispersion processes. This dispersion method is also inherently safer than some prior art processes, because it does not require strong bases, such as aqueous sodium hydroxide (caustic), aqueous potassium hydroxide or ammonia. Notably, none of the ionomer, the ionomer-ethylene copolymer blend and the aqueous dispersion contains ammonia.

The dispersion method comprises contacting an article comprising the blend composition with water at a temperature of from about 80 to about 100° C. under atmospheric pressure. In some embodiments, the water temperature is in the range of from about 85 to about 90° C. Surprisingly, the blend compositions described herein are dispersible in water at 80 to 100° C., which is lower than the temperature that was expected based on the prior art, and which requires significantly less energy. The blend compositions are also expected to be dispersible in water at temperatures above 100° C. and under pressures greater than atmospheric.

The blend composition may be formed into an article having any physical form desired, such as powder, pellets, melt cut pellets, coatings, films, sheets, molded articles and the like. The aqueous dispersion may be produced in any suitable vessel, such as a tank, vat, pail and the like. Stirring is useful to provide effective contact of the bulk blend article(s) with water as dispersion proceeds. Preferably, the dispersion is produced in about 1 hour or less, such as in about 30 minutes or in about 20 minutes or less. Due to the surprisingly rapid dispersion of the articles comprising the blend compositions, it is further contemplated that the process may proceed within a pipeline in which the components of the dispersion are charged at one end of the pipeline and form the dispersion as they proceed down the length of the pipeline. For example, the article, such as pellets, may be mixed with water and passed through a heated zone, with or without added mixing, such as through static mixers. Alternatively, the article may be mixed with hot water and passed through a pipeline, with or without added mixing, such as through static mixers.

In one embodiment, the article comprising the blend composition is mixed with water under low shear mixing conditions at room temperature (about 20 to 25° C.) and the temperature of the mixture is raised to about 80 to about 100° C., or to about 85 to about 90° C. In another embodiment, the article comprising the blend composition is mixed with water preheated to a temperature of about 80 to about 100° C., or about 85 to about 90° C., under low shear mixing conditions.

### Aqueous Dispersions

The aqueous dispersion preferably comprises from a lower limit of about 0.001 or about 1 wt % to an upper limit of about 10, about 20, about 30 or about 50 weight %, of the blend composition based on the total weight of the aqueous dispersion. Complementarily, the aqueous dispersion preferably comprises 50 wt %, 70 wt %, 80 wt %, 90 wt %, 99 wt %, or 99.999 wt % of water.

In some preferred embodiments, the aqueous dispersion consists of the blend composition and the water. Optional additives that are known for us in aqueous dispersions may be added to the aqueous dispersion described herein. Significantly, these additives are not necessary. Suitable additives include, without limitation, pigments, fillers, colorants, dyes, plasticizers, solvents, dispersants, surfactants, and rheology modifiers.

Articles Produced from the Aqueous Dispersions

The aqueous dispersion, with or without its optional additives, may be used as an adhesive or a coating, for example, to produce articles comprising or produced from the aqueous dispersion.

The following examples are provided to describe the invention in further detail. These examples, which set forth specific embodiments and a preferred mode presently contemplated for carrying out the invention, are intended to illustrate and not to limit the invention.

### EXAMPLES

The empirical compositions and properties of the polymers used in these Examples are set forth in Table 1, in which “Tm” refers to the melting temperature, and “MI” refers to melt index.

TABLE 1
Polymers

| | E | MAA | MA | MAME | MI | |
|---|---|---|---|---|---|---|
| | Wt % | Wt % | Wt % | Wt % | 2.16 kg/10 min | Other |
| Ionomer | 91 | 19 | — | — | 2 | Tm 83° C. , |
| (Na⁺, 60% | | | | | | 0.97 g/cm³ |
| neutralized) | | | | | | density |
| ECP-1 | 32 | — | 63 | 4.7 | 8 | — |
| ECP-2 | 38 | — | 62 | — | 14 | — |
| ECP-3 | 91 | — | — | 9 | 25 | Tm 108° C. |

Melt blend A was prepared with 67wt % ionomer and 33wt % ECP-3 on a Berstorff ZE-40A×50D UltraTorque® twin-screw extruder (Berstorff GmbH Postfach 61 03 60D-30625 Hannover). The two polymers were fed to the throat of the twin screw extruder via separate Ktron K2G modular gravimetric loss in weight feeders (Coperion K-Tron, 590 Woodbury-Glassboro Road, Sewell, N.J. 08080 USA). The twin screw extruder was fitted with a Gala MAP6 underwater pelletizer (Gala Industries, 181 Pauley St, Eagle Rock, Va. 24085). The extruder screw profile was selected to provide good shear mixing. The extruder operate conditions are summarized in the table below.

TABLE 2
Extruder Operate Conditions

| Blend Number | A | B | F* |
|---|---|---|---|
| Barrel 1 | Uncontrolled | Uncontrolled | Uncontrolled |
| ExtrBarrel2Temp (C.) | 149 | 190 | |
| ExtrBarrel3Temp (C.) | 176 | 186 | 190 |
| ExtrBarrel4Temp (C.) | 179 | 194 | |
| ExtrBarrel5Temp (C.) | 170 | 195 | 190 |
| ExtrBarrel6Temp (C.) | 167 | 188 | |
| ExtrBarrel7Temp (C.) | 173 | 192 | 185 |
| ExtrBarrel8Temp (C.) | 251 | 223 | |
| ExtrBarrel9Temp (C.) | 172 | 191 | 192 |
| ExtrBarrel10Temp (C.) | 176 | 192 | |
| ExtrBarrel11Temp (C.) | 180 | 188 | |
| ExtrBarrel12Temp (C.) | 177 | 186 | |
| ExtrBarrel13Temp (C.) | 179 | | |
| Die Temp (C.) | 200 | 200 | 190 |
| Melt Temp (C.) | 216 | 218 | 227 |
| Extruder Load (%) | 71 | 72 | 70 |
| Extruder screw Speed (RPM) | 350 | 250 | 410 |
| Melt Pressure (PSIG) | 934 | 690 | 414 |
| Gala Cutter Speed (RPM) | 3201 | 2500 | |
| Vacuum Barrel 7 (mm Hg) | None | 760 | |
| Vacuum Barrel 11 (mmHg) | none | 760 | |
| Pellet Blend of A and | | | 200 |
| ionomer (gpm) | | | |
| Ionomer Ktron 1 (kg/hr) | 67 | | |
| ECP-3 Ktron 2 (Kg/hr) | 33 | | 43 |
| Sheer Pelletizer Speed | | | |
| (m/min) | | | |

*Note:
The barrel temperature control zones on the 25 mm W&P were paired up, so that Barrels 2 and 3 are one temperature control zone. Similarly, Barrels 4 and 5, 6 and 7, and 8 and 9 are also paired. The single-hole die was attached to barrel 9 and the strand was water quenched prior to cutting with a Scheer pelletizer model SGS-E (Reduction Engineering GmbH, Scheer Pelletizing Systems, Siemensstrasse 32, 70825 Korntal-Münchingen).

Melt Blends B, C, D, and E were also prepared. The compositions of the blends are set forth in Table 3. For each blend, the two polymers were fed to the throat of the Bertstorff ZE40A twin screw extruder (Berstorff GmbH Postfach 61 03 60D-30625 Hannover) via a Bonnot feeder (The Bonnot Company, 1301 Home Avenue, Akron, Ohio 44310) for the ethylene copolymers (ECP-1 and ECP-2) and via a Ktron K2G modular gravimetric loss in weight feeder (Coperion K-Tron, 590 Woodbury-Glassboro Road, Sewell, N.J. 08080 USA) for the ionomer. The twin screw extruder was fitted with a Gala MAP6 underwater pelletizer. The extruder screw profile was selected to provide good shear mixing. The extruder operate conditions for blend B are summarized in the table above. Other than the feed rates, the operate conditions for blends C, D and E were essentially the same as those described above for blend B.

TABLE 3
Blend Compositions

| | | | ECP | | Ionomer |
|---|---|---|---|---|---|
| | Ethylene | ECP | feed | Ionomer | feed |
| Ex. | Copolymer | content | rate | content | rate |
| No. | (ECP) | wt % | g/min | wt % | g/min |
| B | ECP-1 | 20.0% | 240 | 80.0% | 960 |
| C | ECP-1 | 33.0% | 496 | 67.0% | 804 |
| D | ECP-2 | 10.0% | 240 | 90.0% | 966 |
| E | ECP-2 | 33.0% | 496 | 67.0% | 804 |

Dispersions of the polymer blends were prepared according to the following procedure. The amount of each component in the blends is set forth in Table 4, below. Table 4 also includes the melt index in gm/10 min, measured on the pellets collected from each melt blend as per ASTM D1238 (190° C., 2.16 kgload). The equipment used was:
1. Pyrex Griffin beaker (800 ml) supplied by Sigma Aldrich Canada
2. DATAPLATE® Digital Hot Plate model PMC 730 hotplate (Barnstead|Thermolyne, 2555 Kerper Blvd. Dubuque, Iowa 52004-2241)
3. Six-bladed mixing head driven by a Calframo BDC2002 (Caframo Limited 501273 Grey Road 1, Georgian Bluffs ON N0H 2T0, Canada) stirrer.

Deionized water and polymer pellets were added to the beaker at ambient temperature. The beaker was placed on the hot plate, and the 6-bladed stirrer was positioned in the center of the beaker with the blades just above the bottom of the beaker. The top of the beaker was covered with foil to minimize evaporation. The water and pellets were heated with stirring (300 rpms) until the temperature of the water reached 90 to 95° C. The hot plate settings were adjusted periodically as necessary to maintain the water temperature in this range, and to avoid boiling the water during dispersion preparation. After 20 to 30 minutes of stirring and heating, a milky white dispersion formed. To verify the quality of the dispersion, it was poured through an 80 mesh stainless steel filter.

TABLE 4
Dispersion Compositions

| | | | | | | | | Nominal | |
|---|---|---|---|---|---|---|---|---|---|
| | Deionized | Blend A | Blend B | Blend C | Blend D | Blend E | Blend F | solids | |
| Ex. | Water | MI 0.51 | MI 4.6 | MI 2.4 | MI 8.6 | MI 6.9 | MI 1.79 | content | |
| No. | (gms) | (gms) | (gms) | (gms) | (gms) | (gms) | (gms) | wt % | Dispersed |
| 1 | 410 | 112 | | | | | | 21% | No |
| 2 | 450 | 50 | | | | | | 10% | No |
| 3 | 450 | | 50 | | | | | 10% | Yes |
| 4 | 450 | | | 50 | | | | 10% | Yes |
| 5 | 450 | | | | 50 | | | 10% | Yes |
| 6 | 450 | | | | | 50 | | 10% | Yes |
| 7 | 270 | | | | | | 30 | 10% | Yes |

The dispersions of Example Nos. 1 and 2, prepared with blend A, did not disperse at the 21% or 10 wt % solids loading. Blend A was re-extruded in this case using a ZSK-25 (25mm diameter, 37/1 L/D) Krupp Werner & Pfleiderer (now Coperion) Extruder 25 mm with additional ionomer to make melt Blend F. Blend F was comprised of 60 wt % of Blend A and 40 wt % of ionomer (3 kg of Blend A and 2 kg of ionomer). The pellets were tumbled in a bag for 60 seconds and then fed into the throat of the extruder using a K-tron loss in weight feeder. The nominal loading of ECP-3 in Blend F was 20 wt %. Blend F and water produced a hot water dispersion.

While certain of the preferred embodiments of this invention have been described and specifically exemplified above, it is not intended that the invention be limited to such embodiments. Various modifications may be made without departing from the scope and spirit of the invention, as set forth in the following claims.

1. An aqueous dispersion comprising water and about 0.001 to about 50 weight % of a blend composition, said blend composition comprising
(a) about 60 to about 99.9 weight %, based on the total weight of (a) and (b), of an ionomer composition comprising or consisting essentially of an ionomer that is a neutralized product of a parent acid copolymer, wherein the parent acid copolymer comprises about 18 to about 30 weight % of copolymerized units of acrylic acid or methacrylic acid, based on the total weight of the parent acid copolymer, and a complementary amount of copolymerized units of ethylene; the parent acid copolymer having a melt flow rate (MFR) from about 200 to about 1000 g/10 min, measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to form the ionomer, said ionomer comprising copolymerized carboxylic acid salts of potassium cations, sodium cations, or or both potassium cations and sodium cations; and
(b) about 0.1 to about 40 weight %, based on the total weight of (a) and (b), of (i) an ethylene elastomer comprising copolymerized units of ethylene, about 50 to about 80 weight % of copolymerized units of at least one alpha,beta-ethylenically unsaturated carboxylic acid ester, and optionally about 0.5 to about 10 weight % of copolymerized units of 2-butene-2,4-dioic acid or its derivative, wherein the derivative is an anhydride of the acid or a monoalkyl ester of the acid, wherein the weight percentages are complementary and based on the total weight of the ethylene elastomer; or (ii) an ethylene dicarboxyl copolymer comprising copolymerized units of ethylene and copolymerized units of a dicarboxyl comonomer comprising an anhydride group, a vicinal pair of carboxylic groups, or a carboxylic group adjacent to an alkoxycarbonyl group.

2. The aqueous dispersion of claim 1, wherein the mixture of polymers consists essentially of the ionomer and the ethylene elastomer.

3. The aqueous dispersion of claim 2, wherein the ethylene elastomer comprises an ethylene methyl acrylate dipolymer comprising copolymerized residues of ethylene and about 55 to about 80 weight % of copolymerized units of the at least one alpha,beta-ethylenically unsaturated carboxylic acid ester.

4. The aqueous dispersion of claim 2, wherein the ethylene elastomer comprises a terpolymer comprising ethylene, about 50 to about 80 weight % of an alkyl(meth)acrylate, and about 0.5 to about 10 weight % of a 2-butene-2,4-dioic acid or its derivative wherein the derivative is an anhydride of the acid or a monoalkyl ester of the acid.

5. The aqueous dispersion of claim 2, wherein the ethylene elastomer comprises a terpolymer or a tetrapolymer comprising ethylene, about 10 to about 40 weight % a first alkyl(meth)acrylate, about 15 to about 65 weight % of a second alkyl(meth)acrylate different from the first, such that the total of the alkyl(meth)acrylates is about 55 to about 80 weight % of the total weight of the ethylene elastomer, and, optionally, about 0.5 to about 10 weight % of a 2-butene-2,4-dioic acid or its derivative.

6. The aqueous dispersion of claim 1, wherein the mixture of polymers consists essentially of the ionomer and the ethylene dicarboxyl copolymer.

7. The aqueous dispersion of claim 6, wherein the ethylene dicarboxyl copolymer comprises copolymerized units of ethylene and about 6 to about 15 wt % of the copolymerized units of the dicarboxyl comonomer, based on the total weight of the ethylene dicarboxyl copolymer.

8. The aqueous dispersion of claim 7, wherein the dicarboxyl comonomer comprises a 2-butene-2,4-dioic acid or its derivative, wherein the derivative is an anhydride of the acid or a monoalkyl ester of the acid.

9. The aqueous dispersion of claim 1, comprising the ionomer, and wherein the cations of the carboxylate salts consist essentially of sodium cations.

10. The aqueous dispersion of claim 1, comprising the ionomer, and wherein the cations of the carboxylate salts consist essentially of potassium cations.

11. A method to produce the aqueous dispersion of claim 1, said method comprising the steps of:
(1) providing the solid blend composition, said solid blend composition comprising the ionomer;
(2) mixing the solid blend composition with water heated to a temperature of from about 80 to about 100° C. to produce a heated aqueous blend dispersion; and
(3) optionally cooling the heated aqueous blend dispersion to a temperature of about 20 to 30° C.

12. The method of claim 11, wherein the solid blend composition consists essentially of the ionomer and the ethylene elastomer.

13. The method of claim 11, wherein the solid blend composition consists essentially of the ionomer and the ethylene dicarboxyl copolymer.

14. The method of claim 10, wherein the solid blend composition comprises the ionomer, and wherein the cations of the carboxylate salts consist essentially of sodium cations.

15. The method of claim 10, wherein the solid blend composition comprises the ionomer, and wherein the cations of the carboxylate salts consist essentially of potassium cations.

16. The method of claim 10 wherein the parent acid copolymer has a MFR from about 250 to about 400 g/10 min.

17. A blend composition comprising
(a) about 60 to about 99.9 weight %, based on the total weight of (a) and (b), of an ionomer composition comprising or consisting essentially of an ionomer that is a neutralized product of a parent acid copolymer, wherein the parent acid copolymer comprises about 18 to about 30 weight % of copolymerized units of acrylic acid or methacrylic acid, based on the total weight of the parent acid copolymer, and a complementary amount of copolymerized units of ethylene; the parent acid copolymer having a melt flow rate (MFR) from about 200 to about 1000 g/10 min, measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to form the ionomer, said ionomer comprising copolymerized carboxylic acid salts of potassium cations, sodium cations or combinations thereof; and
(b) about 0.1 to about 40 weight %, based on the combination of (a) and (b), of (i) an ethylene elastomer comprising copolymerized units of ethylene, about 50 to about 80 weight % of copolymerized units of at least one alpha,beta-ethylenically unsaturated carboxylic acid ester, based on the total weight of the ethylene elastomer, and optionally about 0.5 to about 10 weight % of copolymerized units of 2-butene-2,4-dioic acid or its derivative, wherein the derivative is an anhydride of the acid or a monoalkyl ester of the acid; or (ii) ethylene dicarboxyl copolymer comprising copolymerized units of ethylene and copolymerized units of a dicarboxyl comonomer comprising an anhydride group, a vicinal pair of carboxylic groups and a carboxylic group adjacent to an alkoxycarbonyl group.

18. The aqueous dispersion of claim 1, further comprising one or more additives selected from the group consisting of pigments, fillers, colorants, dyes, plasticizers, solvents, dispersants, surfactants, and rheology modifiers.

19. An article comprising or produced from the aqueous dispersion of claim 1.

20. An article comprising or produced from the aqueous dispersion of claim 18.
